(19) United States
(12) Patent Application Publication
(10) Pub. No.: US 2004/0173261 A1
(43) Pub. Date: Sep. 9, 2004

(54) Pressure limiting valve

(76) Inventor: Christian Stoffers, Rheda-Wiedenbruck (DE)

Correspondence Address: Attn: Arlene J. Powers, Gauthier & Connors, LLP, Suite 3300, 225 Franklin Street, Boston, MA, 02110, US

(21) Appl. No.: 10/779,929

(22) Filed: Feb. 17, 2004

(30) Foreign Application Priority Data
Feb. 19, 2003 (DE) 10306927.5-12

(51) Int. Cl. F16K 17/10

(52) U.S. Cl. 137/489

(57) ABSTRACT

A pressure limiting valve for a fluid medium under system pressure, with a valve housing, in which are provided an inlet channel and an outlet channel communicating therewith for the medium, wherein the flowrate of the medium can be regulated by an axially movable valve body, in effective connection with an energy accumulator, and interacting with a valve seat, is so configured that a piston coaxially adjoining the valve body bounds with its lateral surface a throttle gap, which communicates with the inlet channel and can be subjected to pressure directly or indirectly by the energy accumulator.

### BACKGROUND OF THE INVENTION

1. Field of the Invention

The present invention relates to a pressure limiting valve for a fluid medium under system pressure.

2. Description of Prior Art

Pressure limiting valves are used preferably in high-pressure units, such as high-pressure spray guns or the like, in which the medium, preferably water or a comparable medium, is under a system pressure of, for example, >1000 bar.

Some pressure limiting valves have a pilot valve and others do not. In either case, an energy accumulator is provided to limit the pressure, which exerts a predetermined pressure directly or indirectly on the valve body.

The afore-mentioned high system pressures place special requirements on gaskets and similar wearing parts, which unfavorably influence not only the production costs of a pressure limiting valve, but also its lifetime.

Known pilot valves are designed so that the control pressure applied to the valve body is produced by separate throttles or nozzles, through which medium is carried from the inlet channel into control lines under pressure reduction, which act on the valve body and also act on a control element with a pilot cone, for example, against which pressure is exerted by the energy accumulator.

The energy accumulator here can consist, for example, of a pneumatic cylinder, whose air pressure is adjustable.

However, it is also conceivable to provide an electromagnet as the energy accumulator, or a compression spring, whose force is likewise adjustable.

The installing of control lines as well as various separate throttles or nozzles in the valve housing, and the pilot valve coupled with them, involves a considerable fabrication expense, with consequently high production costs.

Furthermore, the known pressure limiting valves are not suitable for providing a constant output pressure for the particular connected users when there are several parallel connections to one source of medium, regardless of the number of users switched on or off. Naturally, this often leads to an unsatisfactory work outcome in practice.

### SUMMARY OF THE INVENTION

The present invention is therefore based on the goal of further developing a pressure regulating valve according to the species so that it is structurally simple in design and can be manufactured and operated more cost-effectively, and its usability is improved.

This goal is achieved by a pressure limiting valve having the features of claim 1.

Because of this structural configuration, one can abandon the use of gaskets abutting the valve body or piston, on the one hand, and the valve housing, on the other, which are therefore wearing elements, since the structural assembly formed by the valve body/piston is mounted floating, as it were, without contact relative to the valve housing. The throttle gap only admits a slight amount of the medium, which in the simplest case is taken away by a leakage bore at the end opposite the valve body.

Preferably, the piston is enclosed by an O-ring over its entire circumference, which is firmly inserted in the valve body and whose inner wall, together with the lateral surface of the piston, forms a boundary for the throttle gap.

This O-ring, according to an advantageous further development of the invention, is made from a wear-resistant material, preferably a hard metal, as is the piston.

The valve body is conically tapering at its free end and centered in a valve seat.

Depending on the system pressure of the medium, and on the pressure of the control element applied by the piston, a gap is formed between the valve seat and the valve body, through which the medium flows to the outlet channel.

Depending on how the control pressure is adjusted, for the same system pressure there results a bigger or smaller gap between the valve body and the valve seat, with a corresponding change in the outflow pressure.

Special advantages result from the invention for a pressure limiting valve that is provided with a pilot valve, with the pilot pressure being produced by the throttle gap between the O-ring and the piston.

One can abandon the control lines, including the corresponding throttles or nozzles, that are provided in the valve housing by the prior art, so that a very simple and cost-effective production results.

Furthermore, the invention has the result that an always constant pressure of the medium prevails at the outlet channel of each user in a layout with several users connected to a common source of system pressure, regardless of how many users are working or are switched off.

According to another advantageous embodiment of the invention, the inlet channel is allowed to emerge at the side into a pressure chamber, which leads at one end to the valve seat or to the gap formed with the valve body, and at the other end to the throttle gap. With this structural embodiment, one can eliminate the separate throttle for generating the control pressure.

Additional advantageous embodiments are described in the subclaims.

### BRIEF DESCRIPTION OF THE DRAWINGS

Sample embodiments of the invention will be described below with reference to the enclosed drawings.

FIG. 1 is an embodiment of the invention in a cutaway side view; and

FIG. 2 is another embodiment of the invention, likewise depicted as cutaway side view.

### DETAILED DESCRIPTION OF THE INVENTION

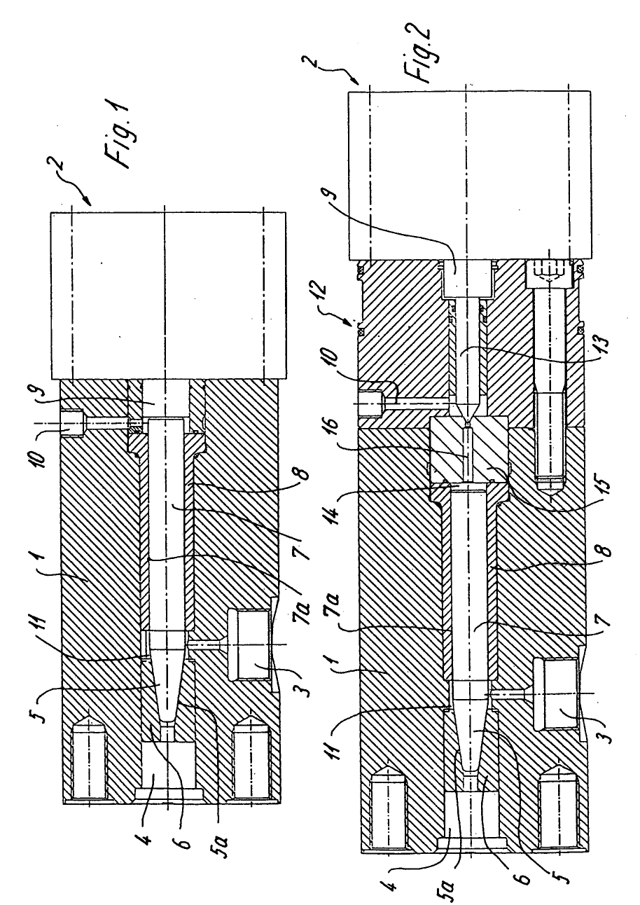

FIG. 1 shows a pressure limiting valve, which presents a valve housing, having a valve housing 1, onto which an energy accumulator 2, such as one in the form of a pneumatic cylinder, is flanged.

In the valve housing 1 there is provided a valve body 5, which together with a piston 7 forms a structural assembly that is in turn subjected to a predetermined pressure by a piston 9 of the energy accumulator 2 at its end face opposite the valve body 5.

The valve body 5 is conically fashioned and lies centered in a valve seat 6, free of contact during its functioning and forming a gap 5a, the receiving part of the valve seat 6 for the valve body 5 being adapted to its slope and contour.

At the side, i.e., transverse to the valve body 5/piston 7 structural assembly, there is introduced into the valve housing 1 an inlet channel 3, through which a fluid medium under system pressure, preferably water, can be admitted, and the inlet channel 3 emerges into a pressure chamber 11.

The piston 7 is mounted with slight play in a stationary sealing sleeve 8 and can move axially, such that a throttle gap 7a is formed by the play, being bounded by the inner surface of the sealing sleeve 8 and the lateral surface of the piston 7.

The pressure chamber 11 is arranged in the transition region between the valve body 5 and the piston 7, so that both the gap 5a and the throttle gap 7a are connected in this way.

The slight amount of medium escaping during operation through the throttle gap 7a during the pressure reduction is carried away by a leakage bore 10, and the amount depends on the system pressure.

In the embodiment shown in FIG. 2, the pressure limiting valve also has a pilot valve 12, which is arranged between the energy accumulator 2 and the valve housing 1.

This pilot valve 12 includes a receiving part 15, which is mounted in the valve housing 1 and forms a boundary surface for a pressure space 14, which is bounded at the other end by the end surface of the piston 7 and at the sides by the inner wall of the sealing sleeve 8. Concentrically to the piston 7, a borehole 16 proceeding from the pressure space 14 extends into the receiving part 15, and at the opposite end it is closed by a control cone 13, connected to the pressure piston 9, the closing pressure being determined by the adjustable pressure of the energy accumulator 2.

The medium moving through the throttle gap 7a builds up a control pressure in the pressure chamber 14 and this is applied also to the control cone 13 via the borehole 16.

If the pilot pressure in the pressure space 14 increases by virtue of an increase in the system pressure or because of the switching off of one of many parallel connected users as a result of the medium carried through the throttle gap 7a, the control cone 13 is pushed against the setpoint pressure of the energy accumulator 2, so that the borehole 16 is exposed and a corresponding volume escapes and is carried away by the leakage bore. The control pressure against the piston 7, determining the width of the gap 5a and thus the pressure of the medium, therefore always remains the same, regardless of how many users connected to the medium source with system pressure are switched on or off.

1. Pressure limiting valve for a fluid medium under system pressure, with a valve housing, in which are provided an inlet channel and an outlet channel communicating therewith for the medium, wherein the flowrate of the medium can be regulated by an axially movable valve body, in effective connection with an energy accumulator, and interacting with a valve seat, wherein a piston coaxially adjoining the valve body bounds with its lateral surface a throttle gap, which communicates with the inlet channel and can be subjected to pressure directly or indirectly by the energy accumulator.

2. Pressure limiting valve according to claim 1, in which a pilot valve is arranged between the valve housing and the energy accumulator, wherein the pilot valve has a pressure space at the end of the piston away from the valve body, into which the throttle gap emerges, and which is bounded by the end face of the piston, as well as an oppositely situated receiving part and laterally by the inner wall of the sealing sleeve.

3. Pressure limiting valve according to claim 1 or 2, wherein a pressure chamber is provided in the transition region between the valve body and the piston, into which the inlet channel emerges.

4. Pressure limiting valve according to claim 1 or 2, wherein the inlet channel is arranged transversely to the lengthwise axis of the valve body/piston structural assembly.

5. Pressure limiting valve according to claim 1, wherein the valve body in the operating position is arranged centered in a valve seat, forming a gap.

6. Pressure limiting valve according to claim 1, wherein the valve body tapers toward its end away from the piston

7. Pressure limiting valve according to claim 1, wherein the piston is enclosed on its lateral surface by a stationary sealing sleeve.

8. Pressure limiting valve according to claim 1, wherein the piston and the sealing sleeve are made of a wear-resistant material, preferably hard metal.

9. Pressure limiting valve according to claim 1, wherein a leakage bore is provided in order to carry away the medium moving through the throttle gap in the valve housing.

10. Pressure limiting valve according to claim 2, wherein a borehole communicating with the pressure space is arranged in the receiving part and can be closed at its other end by a control cone, which communicates with the energy accumulator.

11. Pressure limiting valve according to claim 1, wherein the leakage bore is arranged in the region near the place where the control cone abuts the receiving part.
